(19) United States
(12) Patent Application Publication
(10) Pub. No.: US 2015/0007433 A1
(43) Pub. Date: Jan. 8, 2015

(54) DEVICE AND METHOD FOR ASSEMBLING INSULATING GLASS PANES

(71) Applicant: Plus Inventia AG, St. Gallen (CH)

(72) Inventor: Karl Lenhardt, Bad Liebenzell (DE)

(21) Appl. No.: 14/329,900

(22) Filed: Jul. 12, 2014

Related U.S. Application Data
(63) Continuation of application No. PCT/EP2013/000058, filed on Jan. 10, 2013.

(30) Foreign Application Priority Data
Jan. 13, 2012 (DE) 10 2012 000 464.8
Jan. 13, 2012 (DE) 20 2012 000 280.5

(51) Int. Cl. E06B 3/673

(52) U.S. Cl. CPC E06B 3/67373
USPC 29/791

(57) ABSTRACT

A device for assembling insulating glass panes from glass panels includes a first horizontal conveyor having a conveying track, a rotating station, a second horizontal conveyor having two conveying tracks and an assembling and pressing station, wherein the first horizontal conveyor conveys the glass panels, which are to be assembled to insulating glass panes, to the rotating station which respectively pairs two glass panels and the second horizontal conveyor conveys the paired glass panels from the rotating station to the assembling and pressing station. A displacement station is arranged upstream or downstream of the rotating station, wherein a glass panel conveyed by the single-track first horizontal conveyor is movable out of the transport path and can be brought into a parking track by the displacement station.

### CROSS-REFERENCE TO RELATED APPLICATIONS

This continuation application claims priority to PCT/EP2013/000058 filed on Jan. 10, 2013 which has published as WO 2013/104542 A1 and also the German application number 10 2012 000 464.8 filed on Jan. 13, 2012 and application number 20 2012 000 280.5 filed on Jan. 13, 2012, the contents of which are fully incorporated herein with these references.

### DESCRIPTION

1. Field of the Invention

The invention relates to a device for assembling insulating glass panes from glass panels.

2. Background of the Invention

The invention relates to a device for assembling insulating glass panes from glass panels, comprising a first horizontal conveyor having a conveying track, a rotating station, a second horizontal conveyor having two conveying tracks, and an assembling and pressing station, wherein the first horizontal conveyor conveys the glass panels to be assembled to form insulating glass panes to the rotating station, the rotating station pairs two glass panels, respectively, and the second horizontal conveyor conveys the paired glass panels from the rotating station to the assembling and pressing station, and a method for assembling of insulating glass panes from glass panels, wherein the glass panels are conveyed from a single-track first horizontal conveyor to a rotating station, in the rotating station a first of two glass panels forming a glass panel pair is rotated by 180° and is assembled with the second glass panel, and the thus assembled pair of glass panels is conveyed to an assembling and pressing station by a two-track second horizontal conveyor.

Such a device and method is known from DE 44 37 998. In this document a device for assembling of insulating glass panes from glass panels is described, which allows the manufacture of insulating glass panes comprising two or three glass panels. In the first case of a double insulating glass pane, firstly a first glass panel is conveyed on the first horizontal conveyor and reaches the rotating station. The latter has a rotating frame, on which two parallel conveying tracks are provided, which consist, respectively, of a horizontal line of synchronically driven rollers with corresponding diameters, the rotating axis thereof are lying in a common plane and are running in a rectangular angle to the supporting wall of the rotating station. For supporting the glass panels, the rotating station of the known device comprises supporting roller lines, namely one supporting roller line for the two lines of driven rollers, wherein between each of the two driven rollers there is a supporting roller protruding beyond from the upper surface of the driven rollers. One of the two conveyor tracks has a third supporting roller line, which is essentially leveled with the first two supporting roller lines, but is arranged between them in such a way, that the supporting rollers of the supporting roller line engage in spaces between the driven rollers in one of the two conveyor tracks. As soon as the first glass panel has arrived with its rear edge in the rotating frame, the glass panel is stopped in a predefined position and the rotating frame is rotated by 180°. After the rotation movement by 180° is completed and the rotating frame of the rotating station is fixed in this position, the second glass panel provided with a spacer is conveyed in the second conveyor track of the rotating station via the first horizontal conveyor until it stands congruent with the first glass panel. Starting from this position the two glass panels are conveyed by the second horizontal conveyor together and at the same time into the press gap of the assembling and pressing station as soon as this one is ready and open. For this, the two glass panels are moved forward by the two conveyor belts of the second horizontal conveyor until their front ends reach the exit of the assembling and pressing station, where they are stopped in a predefined position. Then the filling of the insulating glass panes with a gas and their assembling to the final insulating glass pane is performed in a known manner. In order to assemble a triple-insulating glass pane consisting of three glass panels, it is provided, that firstly in a known manner a first and a second glass panel are assembled to a glass panel pair. At the same time, the third glass panel is conveyed in the rotating station and there rotated by 180°. As soon as the first and second glass panels are assembled, the thus formed blank is moved out of the assembling and pressing station, is stopped on a following further horizontal conveyor, and the first glass panel is there provided with a further spacer. At the same time, the third glass panel is conveyed into the assembling and pressing station on the second conveyor belt of the movable press plate. Then the blank provided with the second spacer is moved back into the assembling and pressing station and there positioned congruent with the third glass panel, is assembled with the latter, and is optionally provided with a gas heavier than air. Then the assembled triple-insulating glass pane is pressed and conveyed.

The known device and the known method have the disadvantage, that they—particularly in the production of triple-insulating panes—have only low cycle rates and thus a low production capacity. In order to produce a triple-insulating pane, the so produced blank has to be conveyed out of the assembling and pressing station to attach a further spacer to one of the glass panels which make up the blank. Afterwards, the blank together with the spacer has to be conveyed back into the assembling and pressing station, before it can be assembled with third glass panel to a triple-insulating glass pane.

From EP 0 857 849 a method and a device for assembling insulating glass panes from glass panels are known comprising a horizontal conveyor, on which insulating glass panels or their corresponding blanks respectively are standing upright. A supporting unit is arranged above the horizontal conveyor; the insulating glass panels or their corresponding blanks respectively standing on the horizontal conveyor are leaning against this supporting unit. For the assembling the insulating glass panes it is provided that a first glass panel, which is supported on its first surface, is conveyed into the rotating station to a defined position on a first track of the horizontal conveyor. Then, a second glass panel is conveyed into the rotating station to a defined second position on the first track of the horizontal conveyor. Then the first and the second glass panels are transferred in the rotating station to the second track of the horizontal conveyor which is parallel to the first track. This transfer of the first and second glass panel takes place in that the rotating frame of the rotating station, which receives the glass panels, is rotated by 180° around an axis parallel to the glass panels, so that the first and second glass panel, which have been on the first conveying track before are, after the rotation, on the second conveying track of the horizontal conveyor, which extends through the rotating station. By this measure it is achieved, that the first conveying track is free for the transport of the third and fourth glass panel thereto. The third and fourth glass panel are conveyed until they both arrive on the first track of the rotating station, wherein either the first and the second or the third and the fourth glass panel bear a frame like spacer on their not supported side. The two glass panel pairs, i.e. the first and the third and the second and the fourth glass panel, are positioned spaced from each other in parallel and congruent and are conveyed simultaneously into the assembling and pressing station. This known device and method have the disadvantage that they only allow it in a very complicated way to produce triple-insulating glass panes.

It is an object of the present invention, to further develop a device and a method as mentioned above, so that manufacturing of insulating glass panes is possible in a simple and efficient way.

### SUMMARY OF THE INVENTION

The object is achieved in that the inventive device provides that a displacement station is arranged upstream or downstream of the rotating station, by means of which displacement station a glass panel conveyed by the single-track first horizontal conveyor is movable out of the transport path and can be brought into a parking track.

The measures according to the invention advantageously provide that after assembling of a first glass panel pair a third glass panel in a displacement station is moved out of the transport path of the first horizontal conveyor, that a first glass panel of a second insulating glass pane is moved past the such parked third glass panel into the rotating station, that this glass panel is rotated in the rotating station by 180°, that afterwards a second glass panel of a second insulating glass pane is moved past the parked glass panel into the rotating station, that the rotating station assembles the two glass panels and that they are conveyed out of the rotating station, and that the parked glass panel in the displacement station is moved back into the transport path of the first glass conveyor.

A variant of the inventive method provides that after the assembling of the first glass panel pair the third glass panel is moved out of the transport path of the second horizontal conveyor via a displacement station downstream of the rotating station and is parked in a parking track of the displacement station, that two glass panels of a second insulating glass pane are assembled in the rotating station and this glass panel pair is moved past the parked third glass panel, that then this third glass panel is moved back into the transport path of the second glass conveyor, and that then this third glass panel and subsequently a third glass panel of the second triple-insulating glass pane are conveyed into the assembling and pressing station.

A further variant of the inventive method provides that after the assembling of the first glass panel pair a third glass panel is conveyed from the rotating station into the displacement station, that after that displacing the glass panel the rotating station is moved back into its initial position, that then two glass panels of the double insulating panes are assembled in the rotating station to form a glass panel pair, and that after the assembling of this glass panel pair the displaced third glass panel is brought back into the transport path via the rotating station and the third glass panel is moved to the assembling and pressing station.

By the measures according to the invention advantageously a device and a method for assembling of insulating glass panes is provided, which is distinguished by a short cycle time and thus a high production rate. As it is now provided that glass panels, which are not to be assembled with the immediately preceding glass panels to form an insulating pane, are removed from the transport path of the first horizontal conveyor in the displacement station according to the invention and are parked in this station, the production rate of the inventive device and the inventive method is remarkably increased, since is not required any more, particularly when assembling triple-insulating glass panes, to adhere to a complex order of the glass panels during their initial placement. Rather the respective glass panels, which are to be assembled to insulating glass panes, can be placed immediately one after the other, so that the production process is simplified in an advantageous manner. The inventive measures allow now that in the assembling and pressing station a plurality of glass panels are assembled to a corresponding number of insulating glass panes. The device according to the invention and the method according to the invention are particularly suited for model glass panels. A further advantage of the measures according to the invention is that, according to the described device and method, in particular functional glass panels, which have a coating on one surface, can be assembled to respective insulating glass panes.

A further advantageous embodiment of the invention provides that the displacement station is arranged upstream of the rotating station. According to the invention it is provided that the displacement station is arranged between the single-track first horizontal conveyor and the double-track rotating station. By this, it is achieved, that the displacement station can be made in an easy way, as the glass panel to be parked has to be removed only from one single conveying track.

An advantageous embodiment of the invention provides that the displacement station is arranged downstream of the rotating station. Such a measure has the advantage, that herewith a short cycle time of the rotating station can be achieved, as the displacing takes place after the assembling of the glass planes in the rotating station and the displacing of the corresponding glass panel advantageously is done preferably when the required number of paired glass panels, which are to be assembled in the assembling and pressing station, has been paired in the rotating station.

An advantageous embodiment of the invention provides that the glass panel to be displaced is moved by the rotating station to the displacement station. Such a measure has the advantage, that the displacement station can be arranged outside the actual transport path of the glass planes and that the displacement of the glass panel can be accomplished by a rotating movement of the rotating station and a subsequent conveying of the glass panel to be displaced from the rotating station to the displacement station. Such a measure has the advantage, that herewith in a simple manner already existing devices can be upgraded.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 illustrates a front view of a first embodiment of a device for assembling insulating glass panes;

FIG. 2 illustrates a top view of the embodiment of FIG. 1, wherein the rotating station is shown in a rotated position;

FIG. 3 illustrates a perspective view of the structure and operating method of FIG. 1;

FIG. 4 illustrates a perspective view of the structure and operating method of FIG. 1;

FIG. 5 illustrates a perspective view of the structure and operating method of FIG. 1;

FIG. 6 illustrates a perspective view of the structure and operating method of FIG. 1;

FIG. 7 illustrates a perspective view of the structure and operating method of FIG. 1;

FIG. 8 illustrates a perspective view of the structure and operating method of FIG. 1;

FIG. 9 illustrates a perspective view of the structure and operating method of FIG. 1;

FIG. 10 illustrates a schematic presentation of the operating method;

FIG. 11 illustrates a perspective view of an embodiment of the assembling and pressing station;

FIG. 12 illustrates a front and top view of a second embodiment of a device for assembling insulating glass panes;

FIG. 13 illustrates the front and top view of the second embodiment of FIG. 12, wherein now the displacement station is shown in its displacement position;

FIG. 14 illustrates a perspective view of the structure and operating method of FIGS. 12 and 13;

FIG. 15 illustrates a perspective view of the structure and operating method of FIGS. 12 and 13;

FIG. 16 illustrates a perspective view of the structure and operating method of FIGS. 12 and 13;

FIG. 17 illustrates a front and top view of a third embodiment of a device for assembling insulating glass panes;

FIG. 18 illustrates the front view and a top view of the embodiment of FIG. 17, wherein now the rotating station is shown in a rotated position;

FIG. 19 illustrates a perspective view of the structure and operating method of FIGS. 17 and 18;

FIG. 20 illustrates a perspective view of the structure and operating method of FIGS. 17 and 18; and

FIG. 21 illustrates a perspective view of the structure and operating method of FIGS. 17 and 18.

### DETAILED DESCRIPTION OF THE PREFERRED EMBODIMENTS

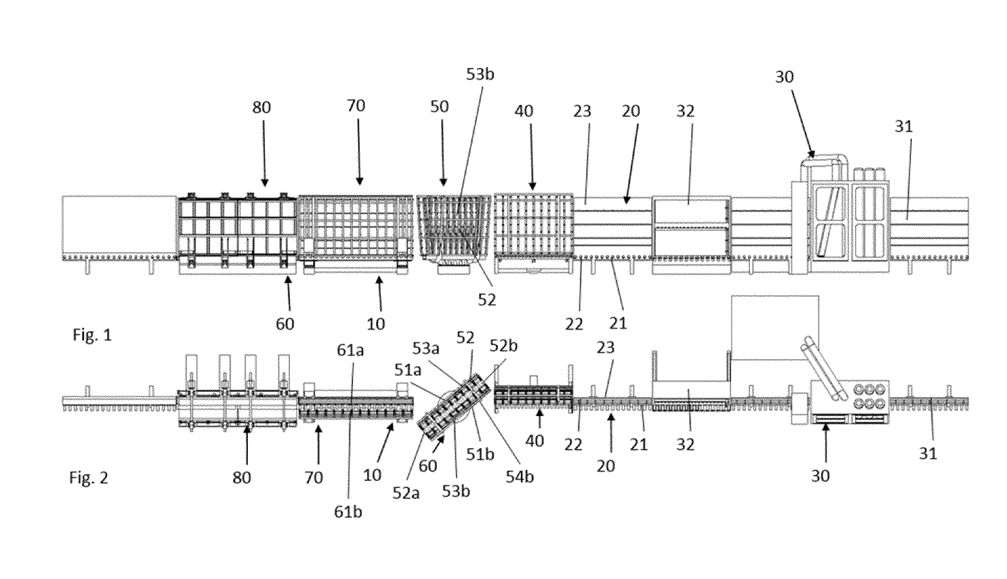

FIGS. 1 and 2 shows an embodiment generally referenced by 10 of a device for assembling of insulating glass panes, the individual stations of which are known and are therefore not described in detail. The device 10 has a single-track first horizontal conveyor 20 having a conveying track 21. The conveying track 21 of the first horizontal conveyor 20 can be made in a known manner by a line of driven rollers 22. It is also possible to use a revolving conveyor band or a similar device. The first horizontal conveyor 20 has a supporting unit 23, which, in the here described embodiment, is inclined towards the vertical, preferably at an angle of 6°, by which supporting unit the glass panels are supported during their transport movement. Such a horizontal conveyor 20 is known too and therefore needs not to be described in detail. It passes a cleaning station 30, in which the glass panels to be assembled for forming an insulating glass pane are cleaned. The glass panels placed in the placing station 31 and cleaned in the cleaning station 30 are brought by the first horizontal conveyor 20 past a checking and frame placing station 32 to a track-changing unit 40, which design and function are described below. Downstream in conveying direction a rotating station 50 is arranged, which has two conveyor tracks 51a and 51b, wherein the conveying track 21 of the first horizontal conveyor 20 (corresponding to the rotating position of the rotating station 50) aligns either with the first conveyor track 51a or with the second conveyor track 51b, so that the glass panels on the first horizontal conveyor 20 can transferred to the conveyor track 51a or 51b of the rotating station 50 being actually aligned with the conveyor track 21. In conveying direction a double-track second horizontal conveyor 60 is following the rotating station 50, which comprises two conveyor tracks 61a and 61b. Those are aligned with the conveyor tracks 51a, 51b of the rotating station 50, so that glass panels located on these conveyor tracks 51a, 51b can be transferred to the conveyor tracks 61a, 61b of the second horizontal conveyor 60.

The second horizontal conveyor 60 traverses a buffering station 70 and an assembling and pressing station 80. The design of a preferred embodiment of the buffering station 70 and the assembling and pressing station 80 are described in the international patent application WO 2005/080739, which is incorporated herewith by reference to avoid repetition and whose disclosure is made the subject matter of this application by reference. In the following the design of the buffering station 70 and the assembling and pressing station 80 are only described in so far, as it seems appropriate or necessary for the understanding of this application.

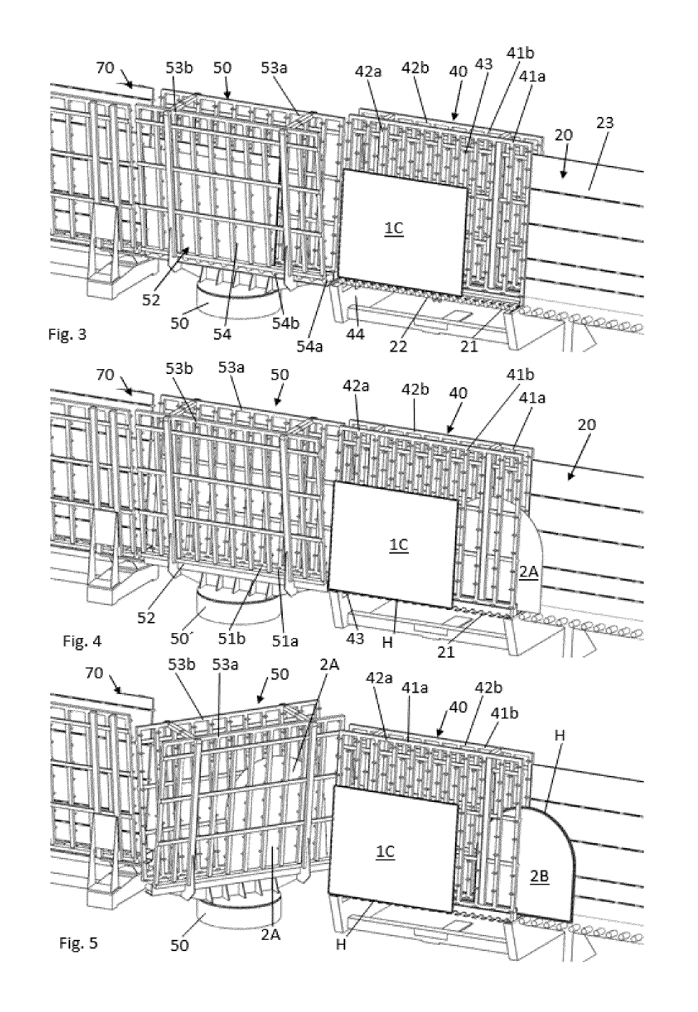

As shown in FIG. 2, a rotating frame 52 of the rotating station 50 is rotatable around an axis which is essentially orthogonal to the conveying direction of the glass panels, so that after a rotation of 180° its (in FIG. 1) front end 52a, which was facing the buffering station 70 before, then faces in this rotated state the first horizontal conveyor 20 and its second end 52b then faces the buffering station 70. The rotating frame 52, which is rotatingly drivable by a driving unit 50′, comprises (as it can be seen from FIG. 3) two supporting walls 53a and 52b, being inclined against the vertical, preferably at an angle of 6°, which have a plurality of supporting rollers 54, along which the glass panels can move. The glass panel supported by the first supporting wall 52a rests with its lower edge on rollers 54a of the first conveyor track 51a and a glass panel supported by the second supporting wall 52b rests on rollers 54b of the second conveyor track 51b. The rotating station 50 is thus made double-tracked and the rollers 54a of the first conveyor track 51a and the rollers 54b of the second conveyor track 51b are independently drivable from each other, so that (as described in the following) on each of the two tracks of the rotating station 50 one or more glass panels located on one of the tracks can be moved independent of the glass panels located on the other track.

Before the glass panels are transported from the cleaning station 30 to the rotating station 50 by the first horizontal conveyor 20, they move through the displacement station 40. It is the object of the displacement station 40 to displace a glass panel located on the conveyor track 21 of the first horizontal conveyor 20, so that a further glass panel situated behind this glass panel can be conveyed from the cleaning station 30 to the rotating station 50 by the first horizontal conveyor 20. The displacement station 40 therefore transfers a glass panel being in this displacement station 40 from the first track made up by the conveyor band 21 of the horizontal conveyor 20 to a second track, in which the such moved glass panel can be “parked”. In order to realize this track-changing-function, the displacement station 40 provides two changing units 41a and 41b, wherein the first changing unit 41a serves to displace the glass panel 1C from the conveyor track 21 of the first horizontal conveyor 20 in its parking position, while then the second changing unit 41b moves in the transport path of the glass panels in the position of the first changing unit 41a. As shown in FIGS. 3 and 4, the changing units 41a and 41b of the displacement station 40 have two supporting walls 42a, 42b inclined with respect to the vertical, preferably at an angle of 6°, which are provided with a plurality of rollers 43, onto which the glass panels run during their transport. The two supporting walls 42a, 42b are movable (preferably in an essentially orthogonal direction to the direction of the conveyor track 21) by a moving unit 44, so that optionally the first supporting wall 42a and the second supporting wall 42b can be moved in the transport path of the glass panels.

FIG. 3 shows the situation in which the first supporting wall 42a (this means the first changing unit 41a) is located in the transport path of the glass panels. It can be seen from this Figure, that the first supporting wall 42a is arranged behind the rollers 22 of the conveyor track 21, so that glass panel 1C conveyed from the cleaning station 30 along the supporting unit 23 of the first horizontal conveyor 20 along the rollers 43 of the first supporting wall 42a can be moved into the rotating station 50.

In FIG. 4 there is now shown a situation, at which the first supporting wall 42a including the glass panel 1C has been removed from the transport path of the first horizontal conveyor 20, by moving the supporting walls 42a, 42b forwardly, so that now the second supporting wall 42b takes the position of the first supporting wall 42a and the glass panel 2A shown in FIG. 4 (as will be described in the following) can be moved by the first horizontal conveyor 20 from the cleaning station 30 to the rotating station 50.

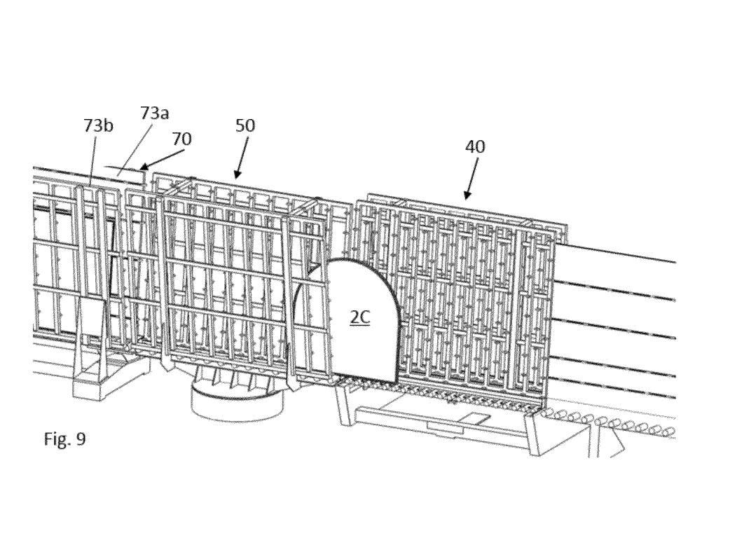

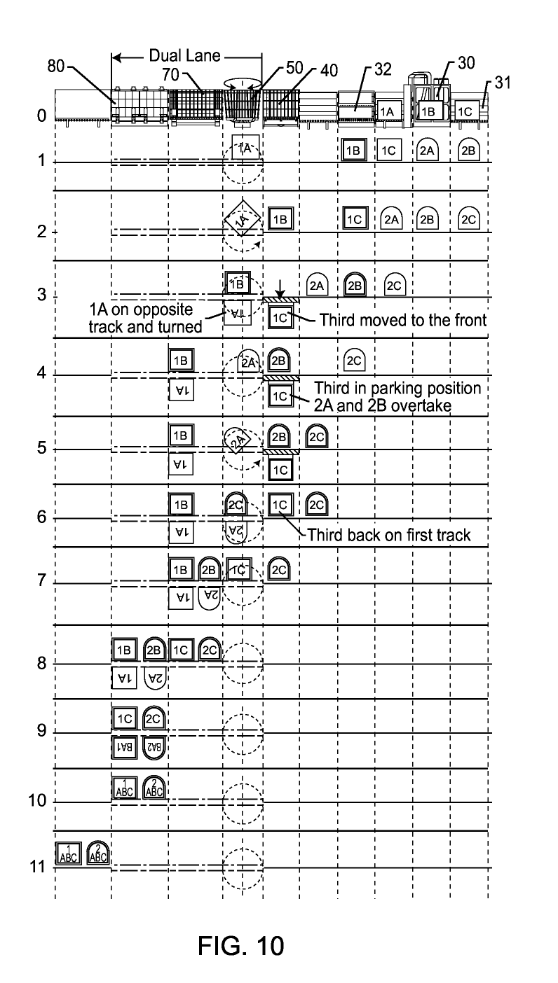

The operation of the device 1 for a production of an triple-insulating glass pane 1ABC consisting of three glass panels 1A, 1B and 1C and a further triple-insulating glass pane 2ABC consisting of glass panels 2A, 2B, 2C is now described with reference to FIGS. 3 to 9 and the operation scheme of FIG. 10. Referring to FIG. 10 the upper half of each line of this operation diagram shows the first track of the transport operation and the lower line shows the second track of the transport operation. Each column represents a step of a production cycle, namely the respective operation step, which is executed in the station shown in line 0 of FIG. 10. The right column of FIG. 10 therefore represents the placing step of the glass panels 1A-1C, 2A-2C in the placing station 31, the next column the cleaning operation in the cleaning station 30, the next column the transport from the cleaning station 30 to the checking and frame setting station 32, the next column the transport from the before-mentioned station to the track-changing unit 40. The next column represents the step performed in the rotating station 50, the following column the feeding of a paired glass panel pair in the buffering station 70, the next column the assembling of the glass panels in the assembling and pressing station 80 and the in FIG. 10 left column represents the exit from the device by means of a further horizontal conveyor.

The glass panels 1A-1C, 2A-2C are respectively placed in the placing station 31 in the before-mentioned order, all three glass panels 1A-1C and 2A-2C, which are to be assembled to a triple-insulating glass pane 1ABC, 2ABC, are placed in an ordered sequence. Such a measure has the advantage, that herewith a huge production safety is given. The first glass panel 1A is (as follows from line 1 of the operation scheme in FIG. 10) conveyed from the cleaning station 30 via the first horizontal conveyor 20 to the rotating station 50. Its first surface moves along the supporting unit 23, its second surface is not impinged during the transport. This has the advantage that herewith no contamination or damage of this surface can occur, so that the method is particularly suitable for functional glass panels. These glass panels are provided at one side (here at the second surface) with a coating. The glass panel 1A passes the displacement station 40 and arrives in the rotating station 50 and is positioned at a corresponding position by means of the conveyor track 51a. Preferably it is herewith provided, that the rotating station 50 has a stop for the front edge of the first glass panel 1A, so that this is stopped in a defined position. Then (as shown in line 2 of FIG. 10) the rotating frame 52 of the rotating station 50 is rotated by 180°, so that its first end is now facing the buffering station 70.

Then (as shown in line 3 of FIG. 10) the second glass panel 1B of the triple-insulating glass pane 1ABC provided with a framelike spacer H in the checking and frame placing station 32 is fed into the rotating station 50 and is positioned by the second conveyor track 51b on the second supporting wall 52b opposite the first glass panel 1A. For achieving a higher cycle time it is preferred that (as follows from the pattern of FIG. 10) the second glass panel 1B is conveyed in such a manner by the first horizontal conveyor 20 that (as can be seen from line 2 of FIG. 10) it is already in the displacement station 40, while the rotating process of the first glass panel 1A in the rotating station 50 is performed.

The two before described method steps are apparent for the skilled person without difficulties, so that they are not shown in FIGS. 3 to 10. FIG. 3 shows now the third method step, which is shown in the operation schema of FIG. 10 in line 3. A third glass panel 1C of the first three glass panels 1A-1C to be assembled to the insulating glass pane 1ABC is positioned in the displacement station 40. In the rotating station 50 there are positioned the paired glass panels 1A and 1B. As it can be seen from line 3 of FIG. 10, there are the three glass panels 2A, 2B and 2C of the second insulating glass pane 2ABC on the horizontal conveyor 20. The glass panels 2A and 2B are to be now also paired in the rotating station 50, wherein the glass panel 1B has a spacer H. In front of them there is the glass panel 1C of the first insulating glass pane 1ABC. The displacement station 40 serves to clear the path for these two glass panels 2A and 2B into the rotating station 50. As shown in FIG. 3, the third glass panel 1C is in the first changing unit 41a of the displacement station 40, supporting itself on the first supporting wall 42a, which at this point in time is located behind the conveyor track 21 of the first horizontal conveyor 20. The first supporting wall 42a and at the same time the second supporting wall 42b are now moved (as described before) by their corresponding movement unit 43, so that the first glass panel 1C is displaced from its track defined by the conveyor track 21 and (as can be seen from FIG. 4) is brought into the “parking track”. As it also can be seen from the before mentioned Figure, then the second supporting wall 42b moves in the position of the first supporting wall 42a, so that the transport path is closed again and the first glass panel 2A of the second insulating glass pane 2ABC can be moved by the first horizontal conveyor 20 to the rotating station 50, thereby overtaking the parked glass panel 1C in the displacement station 40.

As is apparent from line 4 of the operation diagram of FIG. 10, the paired glass panels 1A and 1B located in the rotating station 50 are moved by the second horizontal conveyor 60 from the rotating station 50 to the buffer station 70. The second horizontal conveyor 60 has a plurality of sections independently drivable from each other, so that, e.g., the glass panels located in the buffering station can be moved independently from the glass panels located in the assembling and pressing station 80. Furthermore, the section of the double-track second horizontal conveyor 60 traversing the buffer station 70 is divided in two sections being independently drivable from each other, so that, additionally to the paired glass panels 1A, 1B in an operation step described below at least one further glass panels 2A, 2B can be introduced in the buffer station 70. The first and second conveyor track 61a, 61b of the second horizontal conveyor 60 are proved in the buffer station 70 preferably by two oppositely arranged conveyor tracks, wherein the first conveyor track extends from the exit end of the buffer station to its center and the second conveyor track from the before-mentioned center to the inlet end of the buffer station 70. Of course, it is also possible, to use accordingly driven conveyor rollers or similar devices instead of the conveyor tracks.

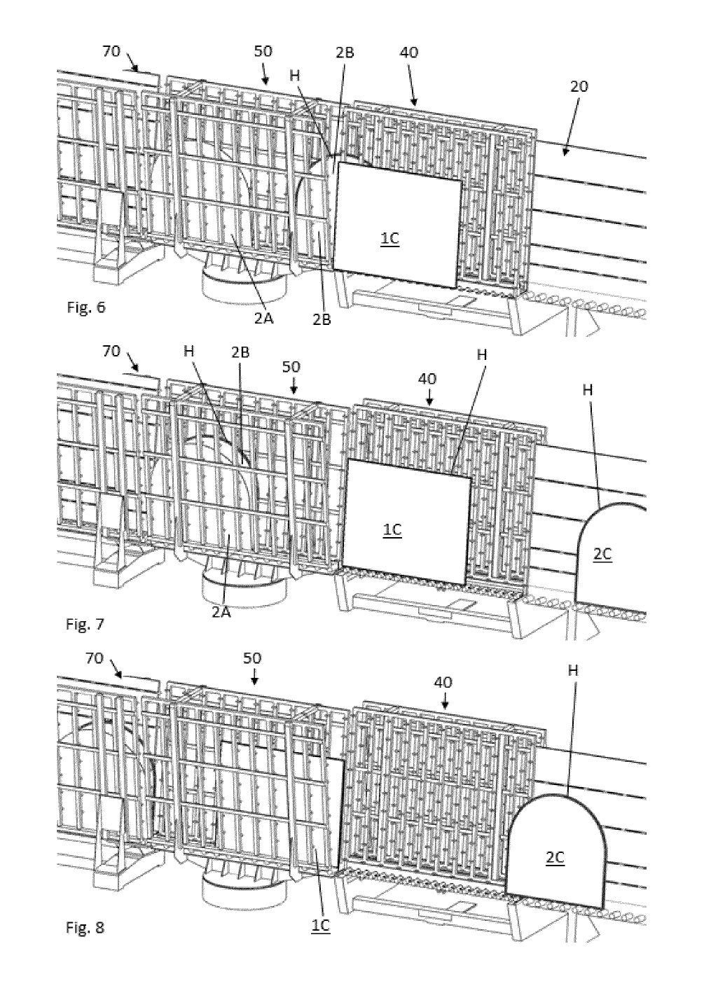

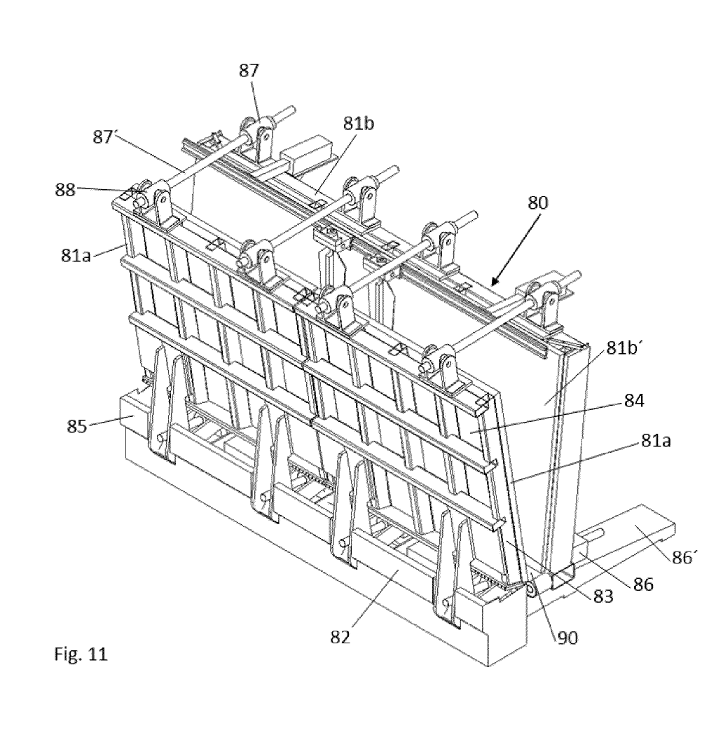

After the paired glass panels 1A, 1B (as shown in line 5 of the operation diagram of FIG. 10) are moved out of the rotating station 50, the glass panel 2A is (like the glass panel 1A) conveyed into the rotating station 50 and is (as shown in FIG. 5 and in line 5 of the operation diagram of FIG. 11) rotated by 180°. Then (as shown in FIG. 6 and in line 6 of the operation diagram of FIG. 11) the second glass panel 2B is conveyed through the displacement station 40 to the rotating station 50, is fed into the latter and is paired with the glass panel 2A.

As now is apparent from line 7 of FIG. 10, the paired glass panels 2A, 2B are removed from the rotating station 50, are fed into the buffer station 70 by the second horizontal conveyor 60 and are positioned at its inlet end. In the buffer station 70 therefore are the paired glass panels 1A, 1B and 2A, 2B. At the same time (as apparent from line 6 of FIG. 10) the third glass panel 1C is moved back by the displacement station 40 from its parking track in its transport track (see FIG. 7), so that it can be then fed (as shown in FIG. 8) by the first horizontal conveyor 20 into the rotating station 50.

As it is now apparent from FIG. 8 and from line 6 and 7 of the operation diagram of FIG. 11, the paired glass panels 2A and 2B are moved into the buffer station 70 by the second horizontal conveyor 60, while the third glass panel 1C is moved into the rotating station 50. Then, the glass panels 1A, 1B and 2A, 2B are conveyed by the second horizontal conveyor 60 into the assembling and pressing station 80 and there are assembled, in a manner known per se, which for the sake of completeness is described in a briefly manner below, to form two blanks 1AB and 2AB, after a space defined by them has been filled with a gas, in particularly with a gas heavier than air. After the paired glass panels 1AB and 2AB have been conveyed into the assembling and pressing station 80, the glass panels 1C, 2C are conveyed into the buffer station 70 by the first horizontal conveyor 60. The simultaneous assembling of two glass panel pairs 1A, 1B has the advantage, that hereby a decrease of the cycle time and therefore a rise of the production capacity of the described device 10 is achieved, as now at the same time two or more pairs of glass panels are filled with a gas heavier than air and are assembled.

After the assembling of the glass panels 1A,1B as well as 2A, 2B to the respective blanks 1AB and 2AB, these are then positioned in the assembling and pressing station 80 (as will be explained briefly in the following) in such a way that they are located on the first track of the second horizontal conveyor 60. The second track is thus free and can receive the third glass panels 1C and 2C. As apparent from lines 8 and 9 of the operation diagram of FIG. 10, then the third glass panels 1C and 2C having respective spacers H are fed by the second horizontal conveyor 60 into the assembling and pressing station 80 and are there assembled to the triple-insulating glass panes 1ABC and 2ABC. These are then conveyed, in a last operation step, as shown in line 11 of the operation diagram of FIG. 11, out of the assembling and pressing station 80.

The next cycle of two further triple-insulating glass panels 1ABC and 2ABC is then performed as described before.

For the skilled person it is apparent from the description above, that the buffer station 70 is not mandatory. If the high cycle rate, provided by the provision of the buffer station 70, is not desired or not necessary, it is possible to omit the buffer station 70 and move the glass panels 1A-1C and 2A-2C directly from the rotating station 50 into the assembling and pressing station 80. Thus, the glass panels 1A, 1B paired in the rotating station 50 are introduced into the assembling and pressing station 80 and then also the glass panels 2A, 2B paired in the rotating station 50 are introduced into the assembling and pressing station, so that then situation shown in line 8, column 2 of the operation diagram of FIG. 10 results. After the assembling of the glass panels 1A, 1B and 2A, 2B to the blanks 1AB and 2AB, then the other glass panels 1C and 2C are (as described above) fed in a direct way into the assembling and press 80. This procedure is not preferred, as it leads to a higher cycle time, but has the advantage, that the buffer station 70 can be omitted.

FIG. 11 shows now schematically the assembling and pressing station 80. It comprises two oppositely arranged supporting units 81a and 81b provided on a frame 82. Each supporting unit 81a and 81b has a respective press plate 81a′, 81b′, each having, at a plurality of points distributed over the press plate, passage holes, which are not shown in the Figures due to clarity issues. The rear sides of the respective press plates 81a, 81b are covered by a hood 83, which is connected with a blower (not shown), by which selectively air can be blown into the chamber 84 formed below the hood 83 or air can be removed from the chambers 84 by suction. The first supporting unit 81a stands on a base 85 which is firmly connected to the frame 82, the rear of its upper end is supported via struts (not shown) on frame 82. The arrangement of the first press plate 81a′ of the first supporting unit 81a is such, that it is inclined to the vertical, preferably by an angle of 6°.

The second supporting unit 81b is mounted on a carriage 86 for a pivotal movement around an axis, the carriage 86 being arranged for a linear displacement movable along rails 86′, which extend in vertical planes relative to the pivot axis and, which are inclined by the same angle with respect to the horizontal as the press plate 81a is inclined relative to the vertical. The carriage 86 is therefore movable in a direction perpendicular to the plane of the press plate 81a. A displacement of the carriage 86 is performed by means of a drive (not shown).

The upper ends of the supporting units 81a, 81b are connected to each other by spindle gears 87, whose spindles 87′ are pivotably seated in a holder 88 mounted on the first supporting unit 81a and driven by a motor. By activating the spindles 87′, the second supporting unit 81b can be pivoted from its initial open position, in which the plates 81a′, 81b′ are arranged in opposition in a V-form at an angle of (here) 12°, into an intermediate position, in which the movable press plate 81b′ of the second supporting unit 81b is arranged in opposite and parallel to the stationary press plate 81a′, preferably at a spacing of 5 to 7 cm. For further details of the design of the assembling and pressing station 80 it is referred to the WO 2005/080739 and its disclosure is incorporated in the disclosure of this application by reference.

During the feeding of the glass panels 1A, 1B and 2A, 2B air is blown through the passage holes of the press plates 81a′, 81b′, so that the glass panels 1A, 2B or 2A, 2B glide on the thus generated air cushion with low friction. Once, the glass panels 1A-2B have reached their positions, no more air is supplied. Then, the second, movable press plate 81b of the supporting unit 81b is pivoted by activating the spindles 87′ in a parallel position with respect to the first press plate 81a, and is moved then, by synchronously activating all spindles 87′, parallel to itself until abutting the opposite glass panels. Air is extracted from the chamber below the movable press plate 81b′ and thus the glass panels 1B, 2B are attached by suction to the movable press plate 81b′ and thus fixed to the movable press plate. The spindles 87′ are then driven in the opposite direction and thus the press plate 81b′ is retracted parallel to itself from the stationary press plate 81a′. Due to the angle of the rails 86′ relative to the horizontal, the glass panels 1B, 2B are lifted by the same angle from the horizontal conveyor 60 and are stopped in a lifted intermediate position for some time. After pivoting in the parallel position a gap only a few millimeters wide is left between the two glass panels 1B, 2B having the respective spacers and the first glass panels 1A, 2A. In this intermediate position now a gas filling is made. For this (as described in the before mentioned WO 2005/080739) sealing strips are provided at the front edge of the two plates 81a′, 81b′ and they are positioned on a belt 90 of the second horizontal conveyor 60 to seal the press plate. In the rear area of the assembling and pressing station 80 a further sealing strip is moved out of the stationary press plate 81a′, which covers the rear edge of the glass panel pair 2A, 2B to cause a sealing there. Then the gap between the belt 90 of the second horizontal conveyor 60 and the movable press plate 81b′ is sealed to prevent an escape of the gas heavier than air opposite to the conveying direction of the horizontal conveyor 60. Then, in a known manner, the filling procedure is performed by feeding gas heavier than air through channels (not shown). By the slanted position of the glass panels 1B, 2B on the belt 90 of the second horizontal conveyor 60 the gap between these glass panels and the belt is, according to the thickness of the insulating glass panes, which are to be produced, between 2 mm and 5 mm wide, which is sufficient for a uniform, nearly pressure free feeding of gas into the intermediate space between the glass panels 1A, 1B or 2A, 2C to replace the lighter air in upward direction along the whole length of the two glass panel pairs 1AB, 2AB without turbulence, and to quickly achieve a high filling level of the gas heavier than air with low losses. As the gas heavier than air is not rising up to the upper edge of the highest glass panel pair 1AB, 2AB, the feeding of heavier than gas can be stopped at a lower level, as the glass panel pairs 1AB and 2AB have to be closed and pressed by moving the movable press plate 81b′ against the stationary press plate 81a′, so that the gas heavier than air between the glass panel pairs 1AB and 2AB is additionally moved upwardly by this closing movement and leads to a full or nearly full filling of the glass panel pairs 1AB and 2AB.

After pressing the glass panels 1A and 1B or 2A and 2B to assemble the glass panels pairs 1AB and 2AB, these glass panel pairs 1AB and 2AB are attached by suction to the movable press plate 81b′ by negative pressure again and the movable press plate 81b′ is moved back in its before mentioned intermediate position, wherein in the lower edges of the glass panel pairs 1AB and 2AB are spaced from the second horizontal conveyor 60, so that the third glass panels 1C and 2C together with the spacers A (as before the second glass panels 1B, 2B) can be fed in the assembling and pressing station 80. The assembling of the glass panel pairs 1AB and 2AB with the corresponding third glass panels 1C and 2C is now performed according to the before described procedure for the assembling of the glass panels 1A and 1B as well as 2A and 2B to form the glass panel pairs 1AB and 2AB.

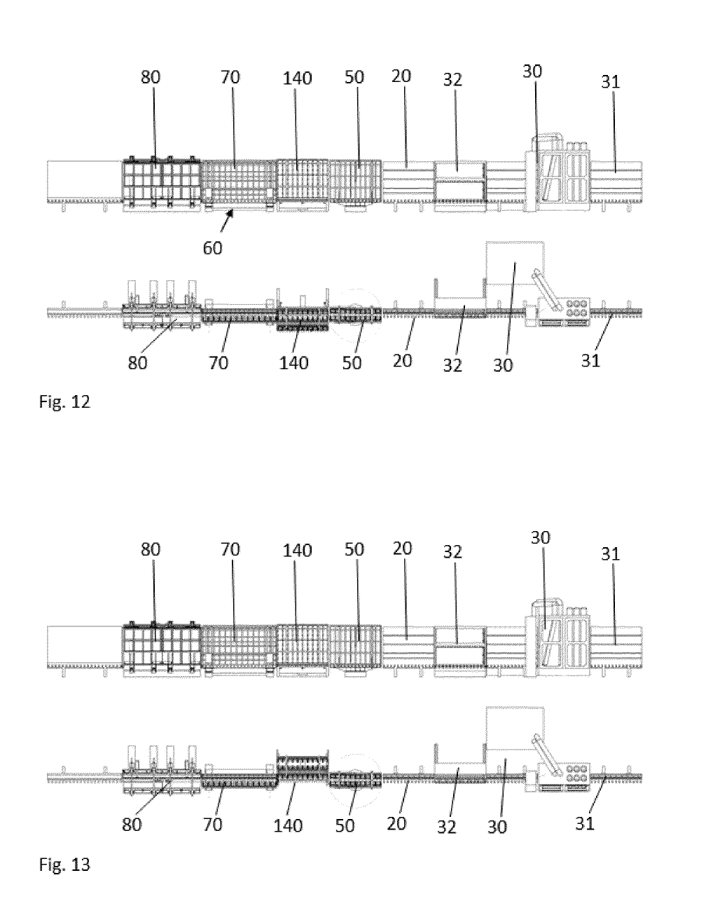

In FIGS. 12 to 16 a second embodiment of a device 10 for the assembling of insulating glass panes from a plurality of glass panels 1A-1C, 2A-2C is shown, wherein corresponding stations and components have the same reference signs and are not described in detail anymore. The essential difference between the first and the second embodiment is that a displacement station 140, whose function corresponds to the displacement station 40, is arranged in the transport path of the glass panels 1A-1C, 2A-2C behind the rotating station 50. In the here described embodiment the displacement station 140 is arranged upstream of the rotating station 50. It is also possible, that the displacement station is arranged downstream of the assembling and pressing station 80, whereas this is not preferred.

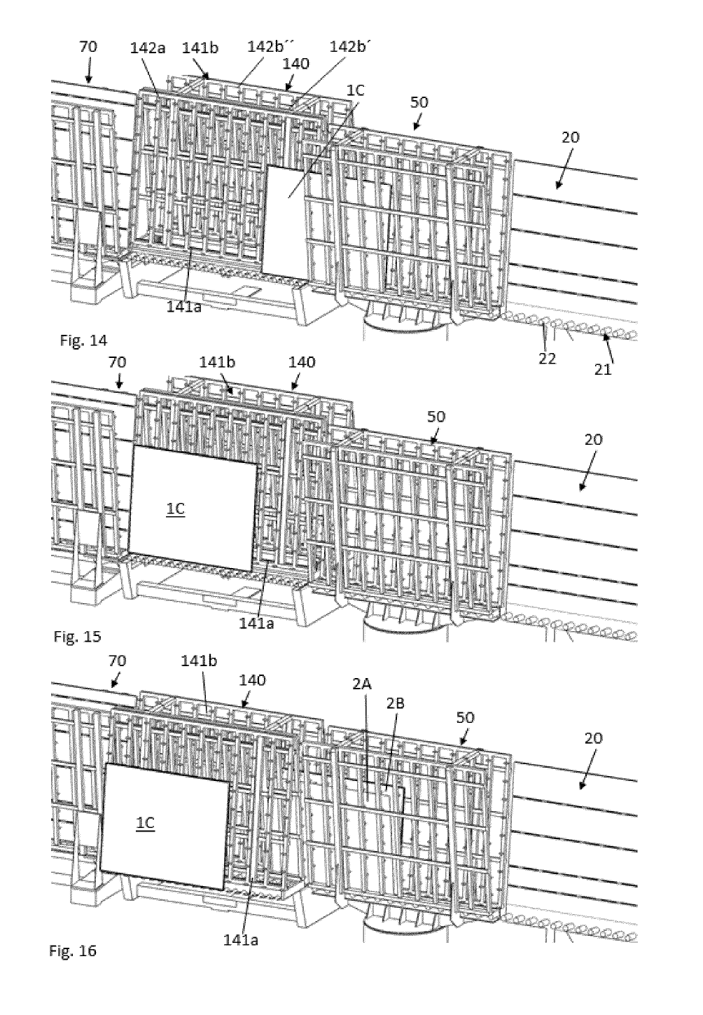

The displacement station 140 is provided with two changing units 141a and 141b, which also serve to displace corresponding glass panels 1C. Since these are positioned in the double-track transport path, which starts at the double-track rotating station 50, this requires a different design as for the displacement station 40 of the first embodiment. This is because the displacement station 40 of the first embodiment is in the single-track transport path of the first horizontal conveyor 20, so that at the latter the glass panels 1C, which are to be displaced, have to be only moved by a single-track transport path into the parking position. In the here described case, the transport path is double-tracked, so that also the glass panel 1C, which is to be displaced, has to be brought on a third track. Because of this, the second changing unit 141b has two supporting walls 142b′ and 142b″, which are (like the corresponding supporting walls 53a and 53b of the rotating station 50 and the supporting walls 73a, 73b of the buffering station 70) inclined, so that the double-track transport path of the paired glass panels 1A, 1AB or 2A, 2B is provided by the second changing unit 141b. Behind the supporting walls 142b′ and 142b″, arranged (as shown herein) in a V-form, is provided a further supporting wall 142a, which forms the first changing unit 141a. The displacement procedure of a glass panel 1C is described using FIGS. 14 to 16.

To move the glass panel 1C out of the double-track transport path, the two changing units 141a and 141b are moved by a moving unit 143 in such a way, that (as shown in FIG. 14) the first changing unit 141a comprising the supporting wall 142a lies in the transport path. The third glass panel 1C is moved from the rotating station 50 into the first changing unit 141a, as shown in FIGS. 14 and 15. Then the first changing unit 141a is moved out of the double-track transport path and the second changing unit 142b takes the place of it. Its two supporting walls 142b′ and 142b″ are aligned with the supporting walls of the rotating station 50, arranged before the displacement station 140, and the supporting walls of the buffering station 70 follow. Thus, a second transport path is given again.

The assembling of three glass panels 1A-1C and three further glass panels 2A-2C to two triple-insulating glass panes 1ABC and 2ABC is made as follows. The glass panels 1A and 1B are paired in the rotating station 50 to a glass panel pair 1AB, pass the displacement station 140 and reach the buffering station 70. The further operation relating to these two glass panels is then as described in the first embodiment. The third glass panel 1C is moved to the rotating station 50 by the first horizontal conveyor 20. In order to displace it, the first changing unit 141a is moved into the transport path and receives the glass panel 1C. By a forward movement of the first changing unit 141a and therefore a forward movement of the second changing unit 141b the double-track transport path is closed again. The glass panel 1C is in its parking position. The glass panels 2A and 2B are then paired in the rotating station 50 as described in the first embodiment, pass the displacement station 140 and reach the buffering station 70. Then the glass panel 1C is moved again in the transport path, by moving back the changing unit 141a, so that the glass panel 1C can be conveyed further. Then, the glass panel 2C is moved through the rotating station 50, the displacement station 140 and buffering station 70 as described in the first embodiment.

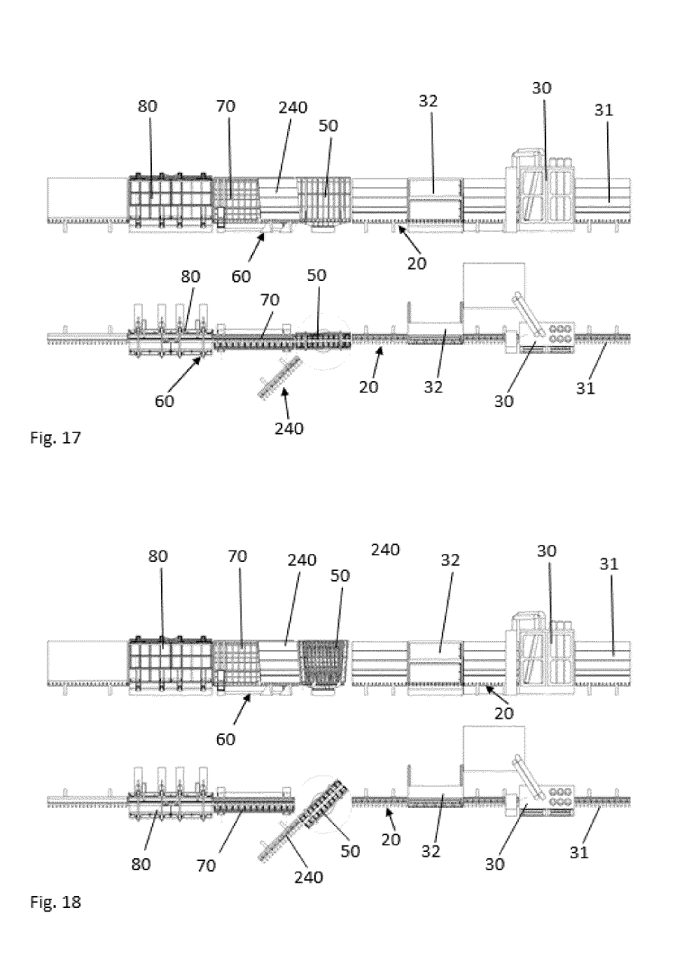

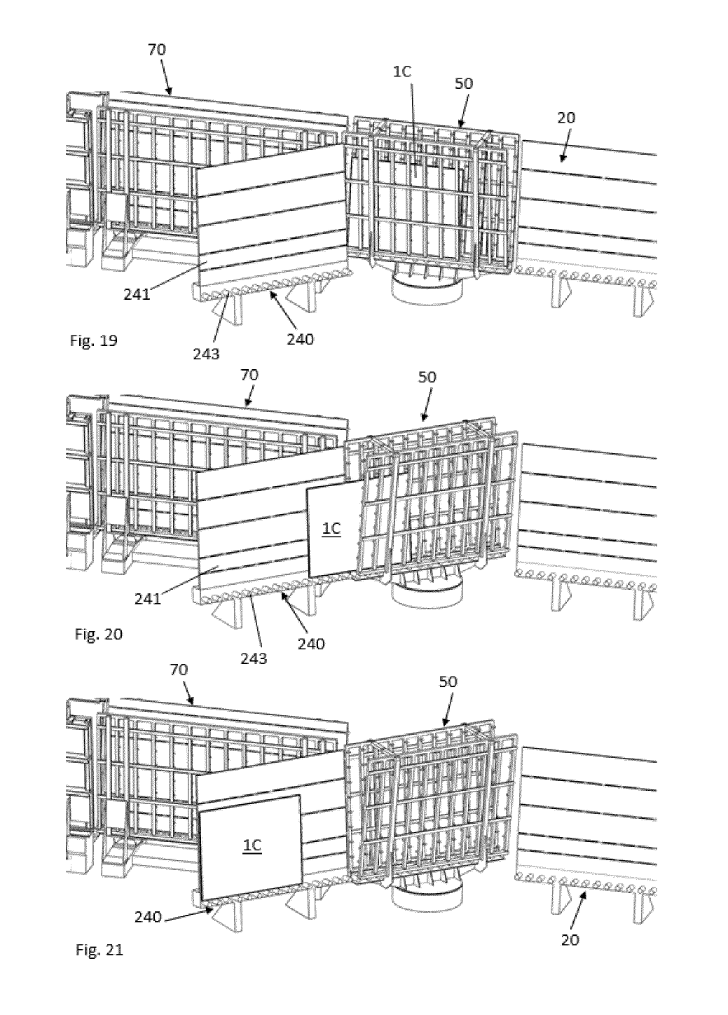

FIGS. 17 to 21 show a third embodiment of device 10 for the assembling of an insulating glass panel, wherein corresponding stations and components are provided with the same reference signs and are not described in detail anymore. The essential difference between the embodiments mentioned before and the third embodiment is that a displacement station 240, which in its function corresponds to the displacement station 40 and 140, is not arranged directly in the transport path of the glass panels 1A-1C, 2A-2C, but it is provided that the glass panel 1C, which is to be displaced, is fed into the displacement station 240 via the rotating station 50. This is made in that the glass panels 1A-1C and 2A-2C are supplied like in the first embodiment. The pairing of the first glass panels 1A and 1B to form the glass panel pair 1AB is done as in the first embodiment. The third glass panel 1C is then fed by the first horizontal conveyor 20 into the rotating station 50. The rotating station 50 is then rotated (as apparent from FIG. 17) by a defined angle smaller than 180°, until it aligns with the displacement station 240. The first glass panel 1C is then moved from the displacement station 240 to the rotating station 50. Then the rotating station 50 is pivoted again in its position, shown in FIG. 17, in which it is in the transport path of the glass panels 1A-2C and 2A-2C. The glass panels 2A and 2B are then, as described before, assembled to a glass panel pair 2AB. A rotation of the rotating station 50 is performed and the removed glass panel 1C is moved back from the displacement station 240 to the rotating station 50. The latter is rotated again until the transport path is closed. The further processing of the glass panels 1C and 2C is as described above. The before described design of the third embodiment has the advantage, that the displacement station 240 can be simply designed. As apparent from FIGS. 18 and 19, only a supporting wall 241 and a conveyor unit 243 are necessary, which allows the glass panel 1C to move from the rotating station 50 into the parking position of the displacement station 240 and to move back in the rotating station 50.

In the before-mentioned description it has been assumed, that in the assembling station two triple-insulating glass panes are produced simultaneously. This is however not mandatory. The described method is suitable also for the case where only one triple-insulating glass pane made out of three glass panels 1A-1C is produced in the assembling and pressing station 80. Also, using an appropriate design of the assembling and pressing station 80, is it possible that more than two triple-insulating glass panes are produced simultaneously by introducing a corresponding number of paired glass panels 1A, 1B, 2A, 2B, etc. in the assembling and pressing station, assembling these to glass panel pairs 1AB, 2AB, 3AB, etc. introducing subsequently third glass panels 1C, 2C, 3C, etc. and (as described for the glass panel pairs 1AB and 2AB) assembling them to triple-insulating glass panes.

Although several embodiments have been described in detail for purposes of illustration, various modifications may be made to each without departing from the scope and spirit of the invention. Accordingly, the invention is not to be limited, except as by the appended claims.

What is claimed is:

1. A device for assembling glass panes from a plurality of glass panels, the device comprising:
a first horizontal conveyor having a single conveying track;
a rotating station arranged downstream from the first horizontal conveyer;
a second horizontal conveyor arranged downstream from the rotating station, the second horizontal conveyor including two conveying tracks;
an assembling and pressing station arranged downstream from the rotating station;
wherein the first horizontal conveyor is configured to convey a plurality of glass panels, which are to be assembled to form glass panes, to the rotating station, the rotating station configured to pair at least two glass panels from the plurality of glass panels to form at least one paired glass panel, and the second horizontal conveyor is configured to convey the least one paired glass panel from the rotating station to the assembling and pressing station; and
a displacement station arranged upstream, downstream or adjacent to the rotating station, wherein at least one glass panel from the plurality of glass panels conveyed by the first horizontal conveyor or rotating station can be moved out of a transport path and can be brought into a parking track.

2. The device according to claim 1, wherein the displacement station is arranged before the rotating station.

3. The device according to claim 2, wherein the displacement station comprises a first and a second changing unit, which can be moved by a moving unit, and that by means of said moving unit the first changing unit can be moved out of the transport path of the first horizontal conveyor and the second changing unit can be positioned in place of the first changing unit.

4. The device according to claim 3, wherein at least one of the first and the second changing units is formed as a supporting wall.

5. The device according to claim 1, wherein the rotating station comprises at least two oppositely disposed supporting walls, the at least two supporting walls each being inclined at an angle from vertical.

6. The device according to claim 1, wherein the rotating station comprises a first and a second independently drivable conveyor tracks, wherein the first independently drivable conveyor track aligns with the single conveying track of the first horizontal conveyor and wherein the second independently drivable conveyor track in a rotated state also aligns with the single conveying track of the first horizontal conveyor.

7. The device according to claim 1, wherein the displacement station is arranged after the rotating station.

8. The device according to claim 7, wherein the displacement station comprises a first and a second changing unit which can be moved by a moving unit, and that by means of said moving unit the first changing unit can be moved out of the transport path of the second horizontal conveyor and the second changing unit can be positioned in place of the first changing unit.

9. The device according to claim 8, wherein the first changing unit comprises a supporting wall and the second changing unit comprises two cooperating supporting walls.

10. The device according to claim 1, wherein the displacement station is arranged externally of the transport path of the first horizontal conveyor, and where the displacement station can be fed by the rotating station.

11. The device according to claim 1, wherein the assembling and pressing station comprises two supporting units each having a press plate, wherein a first press plate is stationary and a second press plate is arranged relatively movable in relation to the first press plate, and that at least one of the press plates in an open position is inclined at an angle from vertical.

12. The device according to claim 1, wherein the second horizontal conveyor comprises a plurality of independently drivable sections.

13. The device according to claim 1, including a buffer station arranged between the rotating station and the assembling and pressing station, where the buffer station includes supporting walls which are inclined at an angle from vertical.

14. The device according to claim 13, wherein the buffer station comprises at least two independently drivable tracks.

15. A device for assembling insulating glass panes from a plurality of glass panels, the device comprising:
a first horizontal conveyor having a single conveying track;
a rotating station arranged downstream from the first horizontal conveyer, the rotating station rotatable about a vertical axis;
a second horizontal conveyor arranged downstream from the rotating station, the second horizontal conveyor including two conveying tracks; and
an assembling and pressing station arranged downstream from the rotating station;
wherein the first horizontal conveyor is configured to convey in series at least two glass panels, which are to be assembled to form an insulating glass pane, to the rotating station, the rotating station configured to pair the at least two glass panels to form at least one paired glass panel, wherein the second horizontal conveyor is configured to convey the least one paired glass panel from the rotating station to the assembling and pressing station; and
wherein the rotating station comprises two supporting walls oppositely disposed each being inclined at an angle from the vertical.

16. The device according to claim 15, wherein the rotating station comprises a first conveyor track and a second conveyor track that are independently drivable from each other, where the first conveyor track is aligned with the single conveying track of the first horizontal conveyor, and the second conveyor track when rotated 180° about the vertical axis is also aligned with the single conveying track of the first horizontal conveyor.

17. The device according to claim 15, including a displacement station arranged upstream, downstream or adjacent to the rotating station, wherein at least one glass panel conveyed by the first horizontal conveyor or rotating station can be moved out of a transport path and can be brought into a parking track.

18. The device according to claim 17, wherein the displacement station comprises two changing units which can be moved by a moving unit, and that by means of said moving unit a first changing unit can be moved out of the transport path of the first horizontal conveyor and a second changing unit can be positioned in place of the first changing unit, wherein at least one of the first and the second changing unit is formed as a supporting wall.

19. The device according to claim 17, wherein the displacement station comprises two changing units which can be moved by a moving unit, and that by means of said moving unit a first changing unit can be moved out of the transport path of the second horizontal conveyor and a second changing unit can be positioned in place of the first changing unit, wherein the first changing unit comprises a first supporting wall and the second changing unit comprises two cooperating supporting walls.

20. The device according to claim 15, including a buffer station arranged between the rotating station and the assembling and pressing station, the buffer station comprising supporting walls which are arranged inclined at an angle from vertical.
